(19) United States
(12) Patent Application Publication
(10) Pub. No.: US 2007/0139795 A1
(43) Pub. Date: Jun. 21, 2007

(54) Image lens assembly

(75) Inventor: Min-Che Li, Taichung City (TW)

Correspondence Address: CHARLES E. BAXLEY, ESQ., 90 JOHN STREET, THIRD FLOOR, NEW YORK, NY, 10038, US

(73) Assignee: Largan Precision Co., Ltd.

(21) Appl. No.: 11/305,318

(22) Filed: Dec. 19, 2005

(51) Int. Cl. G02B 9/00

(52) U.S. Cl. 359/796

(57) ABSTRACT

An image lens assembly comprises a lens array and a transparent material. In the lens array are defined a plurality of spaces. The transparent material is injected into the spaces until the spaces are full of the transparent material, and the transparent material will be solidified after being injected into the interval, so that both lateral surfaces of the transparent material will press closely against the lenses. Therefore, the transparent material can enable the respective lenses to be positioned more firmly.

### BACKGROUND OF THE INVENTION

1. Field of the Invention

The present invention relates to an image lens assembly, and more particularly to an image lens assembly that can prevent dust or moisture from entering the spaces between the respective components of the image lens assembly.

2. Description of the Prior Art

Since the image pick up lens has an increasingly wide range of application, plus the consumer electronic industrial is growing fast, the small image pick-up lens is accordingly found in great demand in different fields, particularly in photographic cell phone and digital camera, or auto's detection system for parking or other purposes. For example, the photographic cell phone is usually equipped with such an image sensor comprised of a solid state imaging device and a lens assembly, such as Charge Coupled Device (CCD) sensor. With the development of science and technology, the photographic cell phone is becoming more and more smaller, therefore the lens assembly in the photographic cell phone also needs to be miniaturized.

FIG. 1 shows a conventional image lens assembly that is disposed behind a protective glass 10 and comprises a plurality of lenses 12, a lens frame 13 and a base 11. The lenses 12 are spaced apart from one another and fixed in the lens frame 13, and the lens frame 13 is fixed on the base 11. An interval C is defined between the lenses 12, and between the base 11 and the lenses 12 is formed a space D. This conventional image lens assembly has the following disadvantages:

First, the protective glass 10, the lenses 12, the lens frame 13 or the base 11 will expand when heated and contract when cooled, so that the fit clearance between the components of the lens assembly also will change, this will lead to an increase in the fit clearance. At this moment, the dust A will come into the interval C between the lenses 12 or into the space D between the base 11 and the lenses 12 through the fit clearance, contaminating the lenses.

Second, moisture B will come into the interval C between the lenses 12 or into the space D between the base 11 and the lenses 12 through the increased fit clearance, causing fogging.

The present invention has arisen to mitigate and/or obviate the afore-described disadvantages.

### SUMMARY OF THE INVENTION

The primary objective of the present invention is to provide an image lens assembly that can prevent dust or moisture from entering the spaces between the respective components thereof. The spaces in the image lens assembly are filled with a transparent material, leaving no room for the dust and moisture.

The secondary objective of the present invention is to provide an image lens assembly that can prevent dust or moisture from entering the spaces between the respective components thereof. The spaces in the image lens assembly are filled with a transparent material, and the transparent material will be solidified after being injected into the interval, so that both lateral surfaces of the transparent material will press closely against the lenses. Therefore, the transparent material can enable the respective lenses to be positioned more firmly.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a conventional lens assembly;

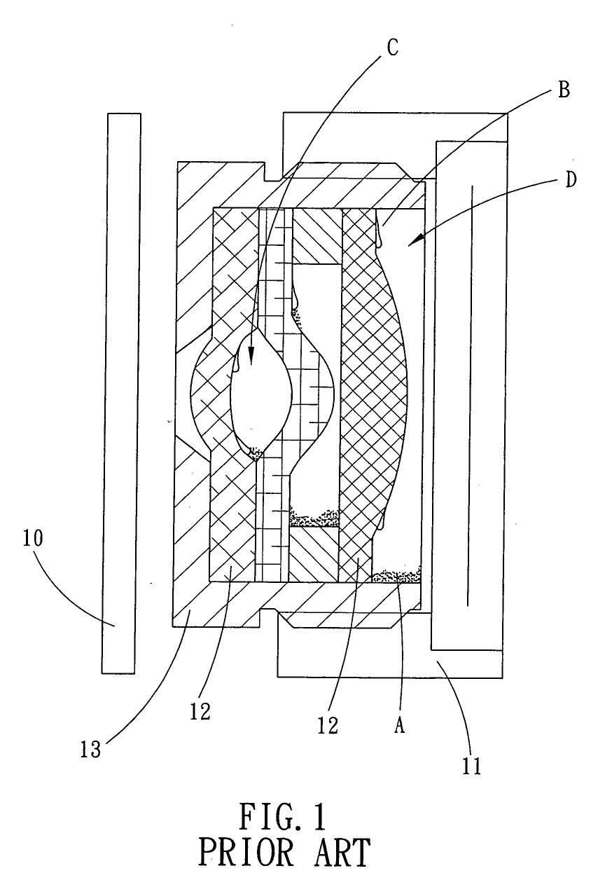

FIG. 2 is a cross sectional of showing an image lens assembly in accordance with a first embodiment of the present invention; and

FIG. 3 is a cross sectional of showing an image lens assembly in accordance with a second embodiment of the present invention.

### DETAILED DESCRIPTION OF THE PREFERRED EMBODIMENTS

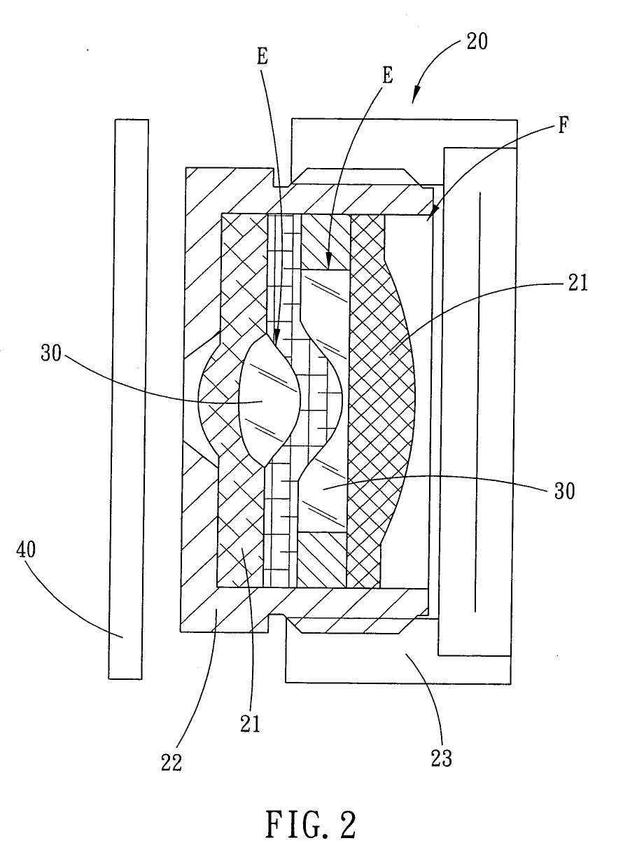

Referring to FIG. 2, an image lens assembly in accordance with a first embodiment of the present invention comprises a lens array 20, a transparent material 30, and a protective lens 40.

The lens array 20 includes a plurality of lenses 21, a lens frame 22, and a base 23. The lenses 21 are fixed in the lens frame 22, and then the lens frame 22 is fixed on the base 23. An interval E is defined between the neighboring lenses 21, and between the base 23 and the lenses 21 is formed a space F.

The transparent material 30 is in the form of a fluid to be injected into in the interval E until the interval E is filled with the transparent material 30, and the transparent material 30 will be solidified after being injected into the interval E, so that both lateral surfaces of the transparent material 30 will press closely against the lenses 21 at both sides thereof.

If the lens array 20 expands or contracts when it is affected by the surrounding temperature, due to the interval E is filled with the transparent material 30, no dust or moisture can enter into the lens array 20 (since there is no room for the dust and moisture to get in). Furthermore, the transparent material 30 can enable the respective lenses 21 to be positioned more firmly.

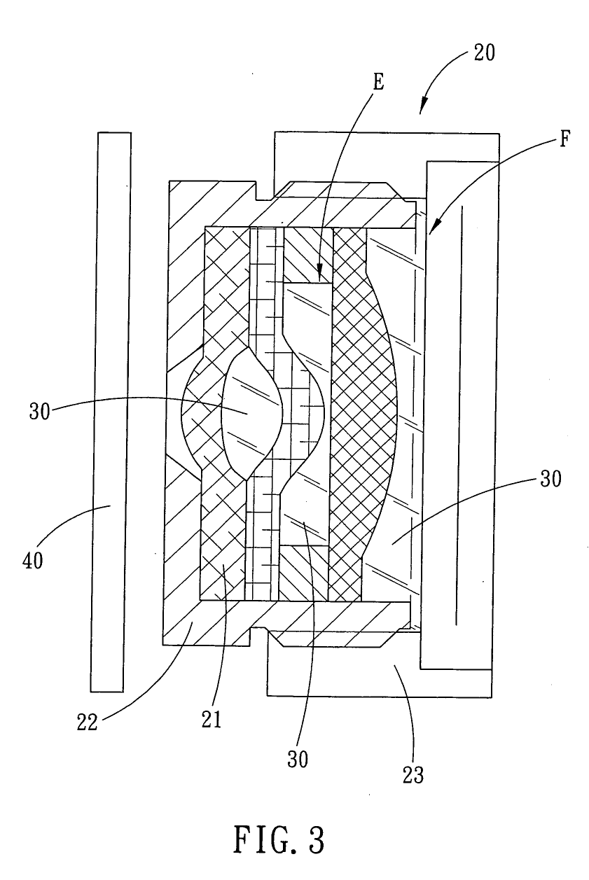

It will be noted that, FIG. 3 shows another embodiment of the present invention, in which, the lens array 20 includes a plurality of lenses 21, a lens frame 22, and a base 23. The lenses 21 are fixed in the lens frame 22, and then the lens frame 22 is fixed on the base 23. An interval E is defined between the neighboring lenses 21, and between the base 23 and the lenses 21 is formed a space F.

The transparent material 30 should be calculated in advance in terms of curvature of the curved surface, so as to enable them to be optimally matched, and the space in the lens array is filled with the transparent material 30. The transparent material 30 is injected into the interval E and the space F until the interval E and the space F are full of the transparent material 30. As a result, no moisture and dust will enter the space F between the lenses 21 and the base 23.

While we have shown and described various embodiments in accordance with the present invention, it should be clear to those skilled in the art that further embodiments may be made without departing from the scope of the present invention.

What is claimed is:

1. An image lens assembly comprising a lens array and a transparent material; wherein
in the lens array are defined a plurality of spaces;
the transparent material is injected into the spaces until the spaces are full of the transparent material.

2. The image lens assembly as claimed in claim 1, wherein the spaces are defined between lenses of the lens array.

3. The image lens assembly as claimed in claim 1, wherein the spaces are defined between lenses and a base of the lens array.

4. The image lens assembly as claimed in claim 1, wherein the transparent material is in the form of fluid.

5. The image lens assembly as claimed in claim 1, wherein the transparent material will be solidified after being injected into the spaces.
